(19) United States
(12) Patent Application Publication
(10) Pub. No.: US 2005/0248797 A1
(43) Pub. Date: Nov. 10, 2005

(54) Resource management

(76) Inventors: Roger Baird, Boise, ID (US); Timothy Blair, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/084,300

(22) Filed: Mar. 17, 2005

Related U.S. Application Data
(60) Provisional application No. 60/554,312, filed on Mar. 17, 2004.

(51) Int. Cl. G06F 15/00

(52) U.S. Cl. 358/1.13; 358/1.15

(57) ABSTRACT

A resource management system includes a memory configured to store a hardcopy job criteria. The resource management system also includes a processor configured to compare an actual hardcopy job attribute with the stored hardcopy job criteria and to selectively trigger an event based on a relationship between the actual hardcopy job attribute and the hardcopy job criteria.

### CROSS-REFERENCE TO RELATED APPLICATION

This application claims priority from copending U.S. Provisional Patent Application Ser. No. 60/554,312, which was filed on Mar. 17, 2004 and entitled “Resource Management,” the completed disclosure of which is incorporated herein by reference for all purposes.

### BACKGROUND

Printers, facsimile machines, photocopying devices, and other such resources are commonly used in a network environment. Such resources can be used by a large number of different individuals, making it difficult to precisely track resource usage. Furthermore, a large percentage of resource usage may be fairly typical usage that does not warrant individual attention. As the volume of resource usage increases, the amount of such uninteresting resource usage can become substantial, making it relatively difficult to focus on abnormal resource usage, which may justify further attention.

### BRIEF DESCRIPTION OF THE DRAWINGS

FIG. 1 is a somewhat schematic view of a network system for monitoring a hardcopy resource.

FIG. 2 schematically illustrates an exemplary menu for initializing hardcopy job criteria.

FIG. 3 schematically shows an exemplary report triggered in response to actual hardcopy job attributes satisfying the hardcopy job criteria of FIG. 2.

FIG. 4 is a flowchart demonstrating a method for monitoring a hardcopy resource.

### DETAILED DESCRIPTION

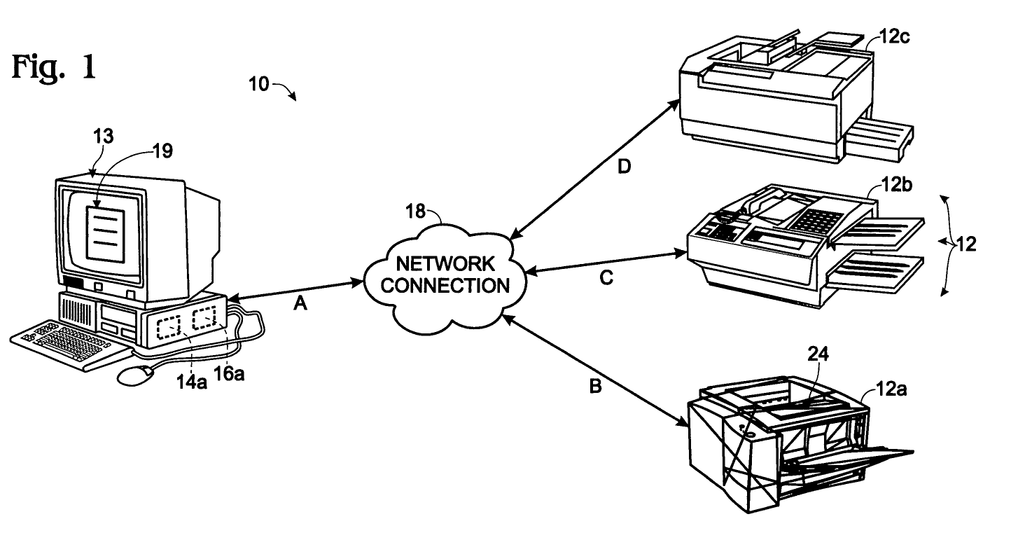

An exemplary network system is shown at 10 in FIG. 1. Network system 10 can include one or more resources, such as hardcopy resources 12a, 12b, and 12c. As used herein, a hardcopy resource is a device or system that can be used to print on or otherwise augment hardcopy media in response to received instructions. As illustrated, network system 10 includes exemplary hardcopy resources in the form of a printer 12a, a facsimile machine 12b, and a photocopier 12c. Such hardcopy resources may be utilized by a single user, or by multiple users, at one or more locations. For example, printers can be used to print various jobs, including text, graphic images, photographs, and the like. Operation of such resources can become expensive. Accordingly, resource managers may desire to track the utilization of hardcopy resources to determine whether such resources are appropriately utilized. Resource managers may also wish to provide for auditing usage of hardcopy resources for billing purposes and/or monitoring individual or departmental use of hardcopy resources.

As shown in FIG. 1, network system 10 may include one or more computers 13, including a memory 14a and a processor 16a. Computer 13 can be configured to cooperate with resources 12 to monitor and/or manage the resources. While exemplary computer 13 is shown as a desktop computer, computer 13 may be virtually any computing device, including a laptop, wireless hand-held, etc. It should be understood that computer 13 can be a remote system connected to one or more resources via the Internet. In some embodiments, computer 13 can be shared among multiple customers to service two or more networks of resources. In some embodiments, a printer, such as printer 12a, may include a memory and/or processor configured to self-monitor and/or manage the printer and/or other networked resources. A processor and memory, or similar componentry, can be used to store data and execute instructions to monitor and manage one or more resources.

The various resources, computers, and other constituent elements of network system 10 can be operatively linked via a network connection 18. Network connection 18 can include any set of wired and/or wireless connections that allow communication between multiple components of network system 10. In some embodiments, the communication may be bidirectional between two or more network system components as indicated by arrow A, arrow B, arrow C, and arrow D. In some embodiments, communication may be unidirectional. The network may include a local area network (LAN). In some embodiments, the network may include a wide area network (WAN), such as the Internet.

Computer 13, and/or another suitable device, such as a resource 12, can be configured to monitor and/or manage a resource. In particular, actual hardcopy job attributes can be monitored. As used herein, an actual hardcopy job attribute describes parameters corresponding to hardcopy resource use. Nonlimiting examples of actual hardcopy job attributes include number of printed pages, number of copies, job origination, job type, user ID, user department, job name, finishing options (including collating or stapling), origination software, and virtually any other information corresponding to how the resource is used.

Actual hardcopy job attributes can be monitored, at least in part, by comparing the actual hardcopy job attributes to hardcopy job criteria. As used herein, hardcopy job criteria include definable parameters corresponding to actual hardcopy job attributes. Such parameters can be stored in memory and used as indicators for identifying how a hardcopy resource is being utilized. Such hardcopy job criteria may be created by an individual hardcopy resource manager. In some embodiments, a resource manager may define hardcopy job criteria by designating criteria pertaining to one or more actual hardcopy attributes the manager would like to monitor. As a nonlimiting example, such designations can be made via an attribute menu which can be displayed as a part of a graphical user interface on computer 13 or on a hardcopy resource, such as on a liquid crystal display 24 of printer 12a.

Hardcopy job criteria may be defined in the form of a magnitude, a range, an alphanumeric code, or virtually any other form of information that can be compared to a particular actual hardcopy job attribute. A hardcopy job criteria may be used as a threshold to which an actual hardcopy job attribute can be compared. Such a threshold may be defined to be a low threshold, which may serve to identify actual attributes that exceed the threshold. For example, a hardcopy job criteria corresponding to a number of pages in a job may be set to “>100.” In this case, when a print job includes more than 100 pages, this criteria is satisfied, and an event may be triggered, as explained below. A hardcopy job criteria may be a high threshold, which may identify hardcopy jobs that fall below the threshold of the hardcopy attribute to which the criteria pertains. It should be understood that such criteria are not limited to numerical comparisons. For example, a hardcopy job criteria may be used to identify if a particular software executable initiates a hardcopy job, if a particular user initiates a hardcopy job, if a job is initiated at a certain time (such as past business hours), etc.

An event may be triggered when one or more actual hardcopy job attributes satisfy a corresponding hardcopy job criteria. An event may function to communicate that such a condition has been satisfied. For example, an event may include the automatic preparation and delivery of a report including details pertaining to the job that satisfied the hardcopy job criteria, thus triggering the report. The report may be automatically delivered to a resource manager so that the resource manager can be automatically alerted. As shown at 19 of FIG. 1, a report can be displayed via a computer, such as computer 13. A report may include contents of the actual hardcopy job, a listing of the actual hardcopy job attributes, and/or a summary that includes information about the triggering hardcopy job as well as related jobs, such as other jobs initiated by the same user, other jobs initiated by the same software executable, etc. Event reports may be delivered in the form of email, instant message, page, facsimile, automated telephone call, etc. In some embodiments, an event may cause information to be automatically stored in memory, such as in a database including information pertaining to resource usage.

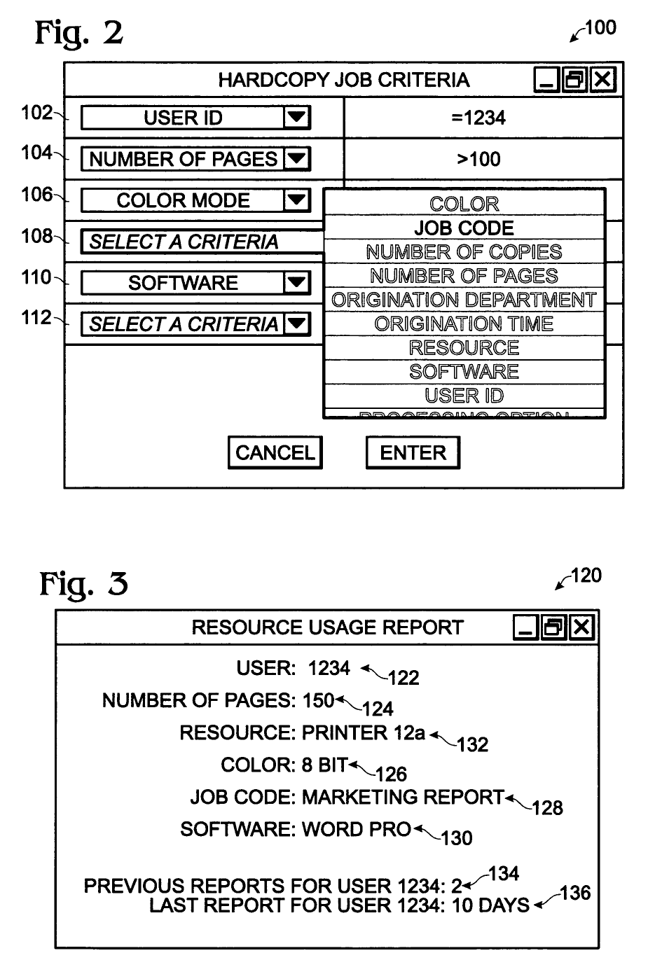

FIG. 2 schematically illustrates an exemplary user interface 100 configured to facilitate initialization of hardcopy job criteria. Such an interface may be configured for compatibility with virtually any operating environment. Furthermore, such an interface may be configured to facilitate initialization of any hardcopy job criteria. In some embodiments, the hardcopy job criteria that are to be considered are selected from a plurality of possible criteria. As a nonlimiting example, FIG. 2 shows a user interface in which the following hardcopy job criteria have been selected: “user ID” 102, “number of pages 104, “color mode” 106, “job code” 108, and “software” 110. As depicted, job code 108 is being selected from a pull down menu. As generally represented at 112, additional hardcopy job criteria may be selected. Selection from a pull down menu is provided as a nonlimiting example of selecting hardcopy job criteria, and virtually any selection method compatible with a particular operating invention can be used without departing from the scope of this disclosure.

As illustrated, a resource manager has entered a criteria of “1234” in the user ID field, and “>100” in the # of pages field. The resource manager has not designated any criteria in the color, job code, or software fields. Thus, with these settings, color, job code and software are not needed for the comparison to actual hardcopy job attributes. The hardcopy job criteria for which values are entered may be stored for comparison with actual hardcopy job attributes. For example, the hardcopy job criteria may be stored in memory 14a of computer 13. Different hardcopy job criteria can be selected and/or designated for each network hardcopy resource, or a global hardcopy job criteria may be selected and/or designated for all networked hardcopy resources.

As described above, actual hardcopy job attributes can be compared to hardcopy job criteria. For example, if user 1234 initiates a hardcopy job in which 150 pages are printed, a component of a network system, such as computer 13, can be used to compare the actual hardcopy job attributes to the designated hardcopy job criteria. In this case, the actual user ID, “1234,” could be compared to the designated user ID, also “1234,” to determine that the user ID criteria is satisfied because the user IDs match. Furthermore, the actual number of pages, 150, could be compared to the designated number of pages, 100, to determine that the # pages criteria is satisfied because more than 100 pages were printed. Because all designated hardcopy job criteria are satisfied, an event may be triggered, such as the automatic generation and delivery of a report.

FIG. 3 schematically shows an exemplary report 120 triggered in response to the hardcopy job criteria of FIG. 2 being satisfied. Report 120 may take the form of an electronic mail message that is automatically delivered to a selected address (or selected addresses), such as the electronic mail address of a resource manager. Report 120 may also take the form of a text message, instant message, page, automated phone call, or any other event. In some embodiments, varying levels of job criteria may be established, which trigger different events. For example, if a print job of 100 or more pages is printed, the job may be saved in a database for further analysis, but if a job of 1000 or more pages is printed, an email may be automatically generated and delivered. Such flexibility in establishing appropriate hardcopy job criteria provides a resource manager with the ability to customize how resources are monitored and managed.

As shown in FIG. 3, a report can include information corresponding to the actual hardcopy job attributes that triggered the designated hardcopy job criteria. For example, report 120 includes user information 122 and # pages information 124, which correspond to the hardcopy job criteria designated in FIG. 2. A report can also contain other information, such as information corresponding to undesignated hardcopy job criteria or information corresponding to previous resource activity. For example, report 120 includes color information 126, job code information 128, and software information 130, which correspond to undesignated hardcopy job criteria. Report 120 also includes resource identifier 132, which names the hardcopy resource for which the report is generated. Exemplary report 120 also includes information corresponding to the user for which the report was generated, including the number of reports the user has previously generated, shown at 134, and when the last such report was generated, shown at 136. Report 120 is provided as a nonlimiting example of an event that may be triggered in response to hardcopy job criteria being satisfied by actual hardcopy job attributes. It should be understood that a report may include additional or alternative information in some embodiments. The particular information provided in a report may be preselected or user configurable.

In some embodiments, a database may be automatically updated in response to actual hardcopy job attributes satisfying designated hardcopy job criteria. In this manner, information of interest to a resource manager may be accumulated in the database so that the resource manager can analyze, manually and/or via programmed algorithms, the data to monitor and manage one or more resources. Such information may be stored in a dedicated database that includes only information resulting from triggered events, or the information can be stored with information related to non-triggering jobs or other information.

Such a database may be queried, manually and/or automatically, thus facilitating a thorough analysis of one or more jobs. For example, the database may be queried to determine, for example, if a particular user printed more than 1000 pages in a particular month, if a particular user printed more that 50% of his/her jobs on expensive color printers, if a particular department printed more than 10,000 pages in a particular month, etc. Hardcopy job criteria may be established that track ongoing resource usage, and if such ongoing usage exceeds the established hardcopy job criteria, an event can be triggered. For example, a usage report documenting resource usage of a particular user may be automatically created and delivered to a resource manager if the resource usage of that user satisfies the hardcopy job criteria.

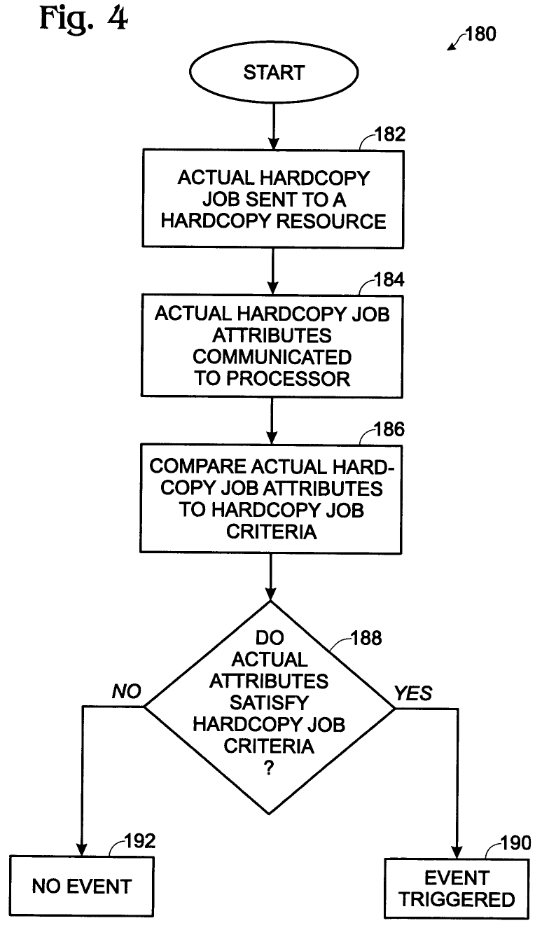

FIG. 4 illustrates a method 180 for managing the utilization of a hardcopy resource. As shown at 182, an actual hardcopy job can be sent to a hardcopy resource, such as a printer, fax machine, or photocopier. At 184, actual hardcopy job attributes are communicated to a processor, such as processor 16a of FIG. 1. Such attributes can be communicated via a network connection, such as network connection 18. At 186, the processor, or another capable device, compares the actual hardcopy job attributes with the hardcopy job criteria, which may be saved in memory, such as memory 14a. At 188, a decision is made as to whether to trigger an event based on the comparison performed at 186. If the actual hardcopy job attributes satisfy the hardcopy job criteria, an event is triggered, as indicated at 190. If the actual hardcopy job attributes do not satisfy the hardcopy job criteria, an event is not triggered, as indicated at 192.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring, nor excluding, two or more such elements.

1. A resource management system, comprising:
a memory configured to store a hardcopy job criteria; and
a processor configured to compare an actual hardcopy job attribute with the stored hardcopy job criteria and to selectively trigger an event based on a relationship between the actual hardcopy job attribute and the hardcopy job criteria.

2. The system of claim 1, wherein the hardcopy job criteria defines a threshold.

3. The system of claim 2, wherein the processor triggers an event if the hardcopy job attribute is greater than the threshold.

4. The system of claim 2, wherein the processor triggers an event if the hardcopy job attribute is less than the threshold.

5. The system of claim 1, wherein the hardcopy job criteria defines an alphanumeric identifier.

6. The system of claim 5, wherein the processor triggers an event if the hardcopy job attribute corresponds to the alphanumeric identifier.

7. The system of claim 5, wherein the processor triggers an event if the hardcopy job attribute matches the alphanumeric identifier.

8. The system of claim 5, wherein the hardcopy job criteria corresponds to at least a job originator, a software executable, an initiation time, a job source, or a job quantity.

9. The system of claim 1, wherein the hardcopy job criteria is defined by a resource manager.

10. The system of claim 1, wherein the hardcopy job criteria is defined via a user interface.

11. The system of claim 1, wherein the hardcopy resource includes one or more of a printer, a photocopier, and a facsimile machine.

12. The system of claim 1, wherein the event includes automatically generating and delivering a report corresponding to a job triggering the event.

13. The system of claim 12, wherein the report includes a listing of actual hardcopy job attributes.

14. The system of claim 12, wherein the report includes a summary of actual hardcopy job attributes.

15. The system of claim 12, wherein the report is sent via email.

16. The system of claim 1, wherein the event includes archiving information corresponding to the actual hardcopy job attributes.

17. The system of claim 1, wherein the processor is configured to compare, to the stored hardcopy job criteria, actual hardcopy job attributes corresponding to two or more discrete hardcopy jobs.

18. A method of managing a hardcopy resource, comprising:
defining a hardcopy job criteria;
comparing an actual hardcopy job attribute to the hardcopy job criteria; and
triggering an event based on comparison of the actual hardcopy job attribute to the hardcopy job criteria.

19. The method of claim 18, wherein the event includes automatically generating and delivering a report corresponding to a job triggering the event.

20. The method of claim 19, wherein the report includes a listing of the actual hardcopy job attributes.

21. The method of claim 19, wherein the report includes a summary of the actual hardcopy job attributes.

22. The method of claim 19, wherein the report is sent via email.

23. The method of claim 18, wherein the event includes archiving information corresponding to the actual hardcopy job attributes.

24. An article comprising: a storage medium having stored thereon machine readable instructions that, upon execution, result in a network system having the capability to:
compare an actual hardcopy job attribute to a defined hardcopy job criteria; and
trigger an event based on comparison of the actual hardcopy job attribute to the hardcopy job criteria.

25. The article of claim 24, wherein the hardcopy job criteria is defined by a resource manager.

26. The article of claim 24, wherein the event includes automatically generating and delivering a report corresponding to a job triggering the event.

27. The article of claim 24, wherein the report includes a listing of the actual hardcopy job attributes.

28. The article of claim 24, wherein the report includes a summary of the actual hardcopy job attributes.

29. The article of claim 24, wherein the report is sent via email.

30. The article of claim 24, wherein the event includes archiving information corresponding to the actual hardcopy job attributes.

31. A resource usage report, comprising;
a listing of at least one actual hardcopy job attribute,
wherein the resource usage report is generated and delivered in response to each of the listed actual hardcopy job attributes satisfying a corresponding hardcopy job criteria.

32. The resource usage report of claim 30, wherein the report includes an electronic mail message.

33. The resource usage report of claim 30, wherein the report includes a database entry.

34. A resource management system, comprising:
means for storing a hardcopy job criteria; and
means for comparing an actual hardcopy job attribute with the hardcopy job criteria and for selectively triggering an event based on a relationship between the actual hardcopy job attribute and the hardcopy job criteria.

35. The system of claim 34, wherein the event includes automatically generating and delivering a report corresponding to a job triggering the event.

36. The system of claim 35, wherein the report includes a listing of actual hardcopy job attributes.

37. The system of claim 35, wherein the report includes a summary of actual hardcopy job attributes.
